(19) United States
(12) Patent Application Publication
(10) Pub. No.: US 2024/0160147 A1
(43) Pub. Date: May 16, 2024

(54) INSTALLATION BRACKET, PROCESS CARTRIDGE ASSEMBLY, AND IMAGE-FORMING APPARATUS

(71) Applicant: Zhuhai Pantum Electronics Co., Ltd., Zhuhai (CN)

(72) Inventor: Feng CHEN, Zhuhai (CN)

(21) Appl. No.: 18/507,983

(22) Filed: Nov. 13, 2023

(30) Foreign Application Priority Data
Nov. 14, 2022 (CN) 202211418824.1

(51) Int. Cl. G03G 21/18

(52) U.S. Cl. CPC G03G 21/1871; G03G 2221/1869

(57) ABSTRACT

The present disclosure provides an installation bracket, a process cartridge assembly, and an image-forming apparatus. The installation bracket is configured to carry a process cartridge and includes a bracket main body, and a connection portion disposed on the bracket main body. The connection portion includes a conductive portion, configured to electrically connect a contact portion of a chip on the process cartridge and an electrical contact portion of an image-forming apparatus. The connection portion is configured as an intermediate part; the contact portion of the chip on the process cartridge is not in direct contact with the electrical contact portion of the image-forming apparatus, thereby reducing error and improving electrical connection stability between the process cartridge and the main body of the image-forming apparatus.

### CROSS-REFERENCE TO RELATED APPLICATION

The present disclosure claims the priority to Chinese patent application No. 202211418824.1, filed on Nov. 14, 2022, the entirety of which is incorporated herein by reference.

### TECHNICAL FIELD

The present disclosure generally relates to the field of image-forming technology and, more particularly, relates to an installation bracket, a process cartridge assembly, and an image-forming apparatus.

### BACKGROUND

An image-forming apparatus often has a built-in drawer, and at least one process cartridge is accommodated in the drawer. By pushing and pulling the drawer, the process cartridge may be installed in the image-forming apparatus, or the process cartridge may be removed from the image-forming apparatus. The process cartridge needs to be electrically connected to a main body side of the image-forming apparatus, such that the main body side of the image-forming apparatus may obtain relevant information of the process cartridge. However, when the drawer is installed in the image-forming apparatus, a certain relative distance (e.g., gap) may be between the process cartridge and the drawer, and between the drawer and the main body side of the image-forming apparatus, which may affect electrical connection stability between the process cartridge and the main body side of the image-forming apparatus.

### SUMMARY

One aspect of the present disclosure provides an installation bracket, configured to carry a process cartridge. The installation bracket includes a bracket main body; and a connection portion, disposed on the bracket main body, where the connection portion includes a conductive portion, configured to electrically connect a contact portion of a chip on the process cartridge and an electrical contact portion of an image-forming apparatus.

Another aspect of the present disclosure provides a process cartridge assembly. The process cartridge assembly includes an installation bracket and a process cartridge. The installation bracket is configured to carry the process cartridge and includes a bracket main body and a connection portion disposed on the bracket main body; and the connection portion includes a conductive portion, configured to electrically connect a contact portion of a chip on the process cartridge and an electrical contact portion of an image-forming apparatus; and the process cartridge is installed on the installation bracket; and the process cartridge includes a contact portion electrically connected to a first docking portion.

Another aspect of the present disclosure provides an image-forming apparatus. The image-forming apparatus includes an electrical contact portion; and an installation bracket disposed removably, where when the installation bracket is installed in the image-forming apparatus, a conductive portion is electrically connected to the electrical contact portion.

Other aspects of the present disclosure may be understood by those skilled in the art in light of the description, the claims, and the drawings of the present disclosure.

### BRIEF DESCRIPTION OF THE DRAWINGS

To clearly describe technical solutions of various embodiments of the present disclosure, the drawings which need to be used for describing various embodiments are described below. Obviously, the drawings in the following description are merely some embodiments of the present disclosure. For those skilled in the art, other drawings may be obtained in accordance with the drawings without creative efforts.

FIG. 1 illustrates a structural schematic of an image-forming apparatus provided by exemplary embodiments of the present disclosure.

FIG. 2 illustrates an enlarged view of a portion A in FIG. 1.

FIG. 3 illustrates a structural schematic of a process cartridge assembly provided by exemplary embodiments of the present disclosure.

FIG. 4 illustrates a structural schematic of an installation bracket provided by exemplary embodiments of the present disclosure.

FIG. 5 illustrates a partial structural schematic of an image-forming apparatus provided by exemplary embodiments of the present disclosure.

FIG. 6 illustrates an enlarged view of a portion B in FIG. 5.

### DETAILED DESCRIPTION

In order to better understand the technical solutions of the present disclosure, embodiments of the present disclosure are described in detail below with reference to accompanying drawings.

It should be understood that described embodiments are only some of embodiments of the present disclosure, rather than all of embodiments. Based on embodiments in present disclosure, all other embodiments obtained by those skilled in the art without making creative efforts should fall within the protection scope of present disclosure.

The terms used in embodiments of the present disclosure are only for the purpose of describing specific embodiments and not intended to limit the present disclosure. As used in embodiments and appended claims, the singular forms “a”, “the” and “said” are also intended to include plural forms, unless the context clearly dictates otherwise.

It should be understood that the term “and/or” used in the present disclosure is only an association relationship describing related objects, indicating that there may be three relationships. For example, A and/or B may indicate three cases: A alone, both A and B, and B alone. In addition, the character “/” in the present disclosure indicate that related objects are an “or” relationship.

It should be noted that the orientation terms such as “upper”, “lower”, “left” and “right” described in embodiments of the present disclosure are described from the perspective shown in the drawings and should not be understood as a limitation on embodiments of the present disclosure. In addition, it should be understood in the present disclosure that when an element is referred to as being connected “on” or “under” another element, it may not only be directly connected “on” or “under” another element, but also may be indirectly connected “on” or “under” another element through an intermediate element.

Any two of “the first direction”, “the second direction” and “the third direction” described in embodiments of the present disclosure are configured to be intersected with each other, that is, any two of above three directions are not in parallel or overlapped with each other.

For example, any two of “the first direction”, “the second direction” and “the third direction” are configured to be perpendicular or approximately perpendicular to each other.

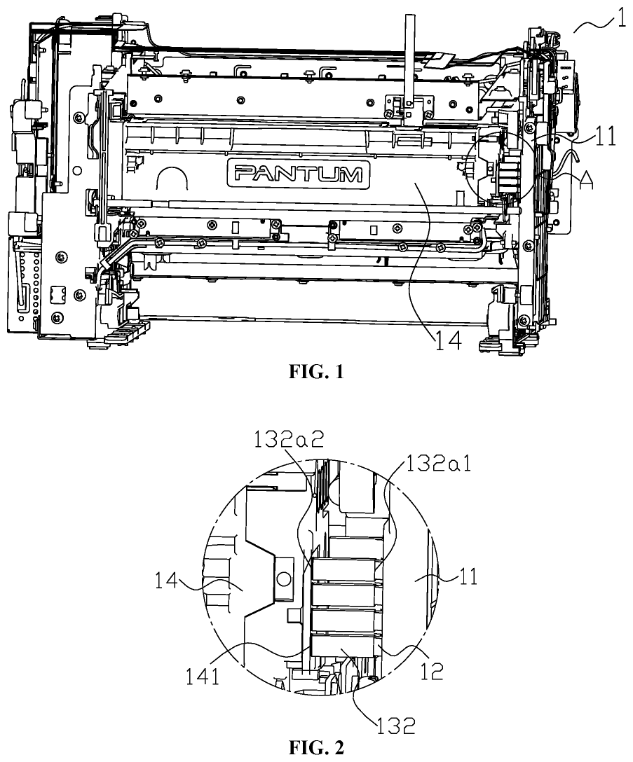

As shown in FIGS. 1-3, embodiments of the present disclosure provide an image-forming apparatus 1. The image-forming apparatus 1 may include an apparatus main body 11, an installation bracket 13 and a process cartridge 14. A chip on the process cartridge 14 may include a contact portion 141, and the apparatus main body 11 may include an electrical contact portion 12. When installing the process cartridge 14, the process cartridge 14 may need to be placed on the installation bracket 13 first; and after the process cartridge 14 is supported and positioned by the installation bracket 13, the process cartridge 14 may be placed in the apparatus main body 11 by pushing and pulling the installation bracket 13, such that the contact portion 141 of the chip on the process cartridge 14 may be electrically connected to the electrical contact portion 12 of the apparatus main body 11 to realize data transmission.

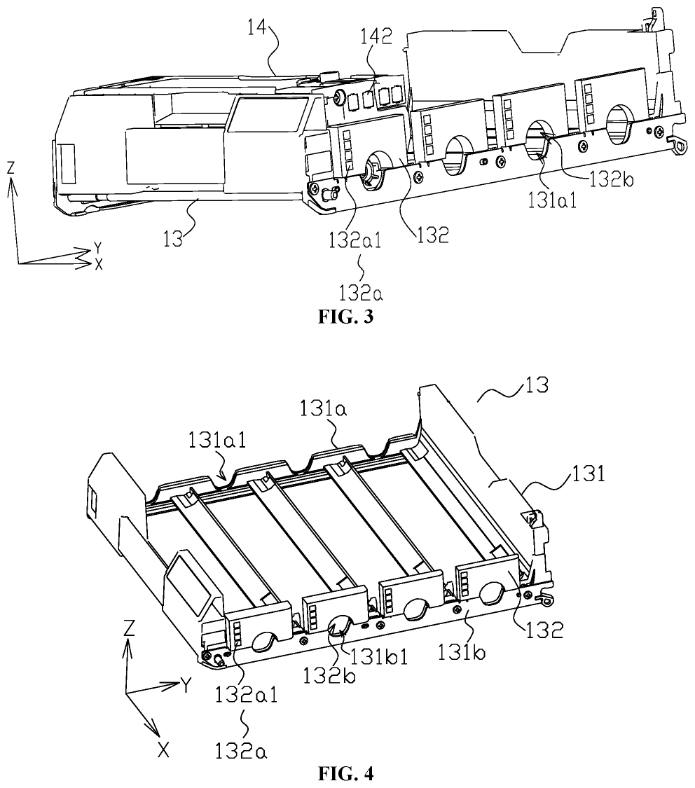

The use of the process cartridge 14 may include two processes which are installing the process cartridge 14 on the installation bracket 13 and installing the installation bracket 13 in the apparatus main body 11. Position deviation or position inaccuracy may occur in above-mentioned two processes, which may result in unstable electrical connection between the process cartridge 14 and the apparatus main body 11. Therefore, as shown in FIGS. 3 and 4, in one embodiment, the installation bracket 13 may include a bracket main body 131 and a connection portion 132; and the connection portion 132 may be disposed at the bracket main body 131. The connection portion 132 may include a conductive portion 132a which may be configured to electrically connect the contact portion 141 of the chip on the process cartridge 14 and the electrical contact portion 12 of the image-forming apparatus 1.

In one embodiment, the connection portion 132 may be disposed on the bracket main body 131 and include the conductive portion 132a. After the installation bracket 13 carrying the process cartridge 14 is installed in the image-forming apparatus 1, the conductive portion 132a may electrically connect the contact portion 141 of the chip on the process cartridge 14 and the electrical contact portion 12 of the apparatus main body 11, which ensures electrical connection stability between the contact portion 141 of the chip on the process cartridge 14 and the electrical contact portion 12 of the apparatus main body 11.

The process of installing the process cartridge 14 in the apparatus main body 11 is described hereinafter. First, the process cartridge 14 may be installed on the installation bracket 13, such that the contact portion 141 of the chip on the process cartridge 14 may be in contact with the conductive portion 132a of the installation bracket 13. Next, the installation bracket 13 carrying the process cartridge 14 may be installed in the apparatus main body 11. As an operator pushes the installation bracket 13 in the apparatus main body 11, the installation bracket 13 may continue to be installed in the apparatus main body 11, such that the state of the conductive portion 132a of the connection portion 132 and the electrical contact portion 12 of the apparatus main body 11 may be changed from a non-contact state to a contact state. When the installation bracket 13 is installed in the apparatus main body 11 in place, the contact portion 141 of the chip on the process cartridge 14 and the conductive portion 132a may be electrically connected to the electrical contact portion 12 of the apparatus main body 11, thereby realizing information transmission between the process cartridge 14 and the apparatus main body 11. In one embodiment, the connection portion 132 may be configured as an intermediate part, such that the contact portion 141 of the chip on the process cartridge 14 may be in indirect contact with the electrical contact portion 12 of the apparatus main body 11, which may reduce error and improve electrical connection stability between the process cartridge 14 and the apparatus main body 11.

Furthermore, as shown in FIG. 4, the bracket main body 131 may include a first side plate 131a and a second side plate 131b which are arranged sequentially along a first direction X. The first side plate 131a and the second side plate 131b may enclose an accommodating space for loading the process cartridge 14; and at least a part of the process cartridge 14 may extend into the accommodating space. When the installation bracket 13 is installed in the image-forming apparatus 1, the second side plate 131b may be adjacent to the electrical contact portion 12 of the image-forming apparatus 1 relative to the first side plate 131a. The connection portion 132 may be located at the second side plate 131b. When the installation bracket 13 is configured to carry the process cartridge 14, the connection portion 132 may be electrically connected to the process cartridge 14.

The first side plate 131a and the second side plate 131b may be spaced apart along the first direction X, such that the first side plate 131a and the second side plate 131b may enclose to the accommodating space for loading the process cartridge 14; and at least a part of the process cartridge 14 may extend into the accommodating space.

In one embodiment, the connection portion 132 may be disposed at the second side plate 131b. When the process cartridge 14 is installed on the installation bracket 13, the connection portion 132 may be electrically connected to the process cartridge 14. When the installation bracket 13 carrying the process cartridge 14 is installed in the apparatus main body 11, the connection portion 132 may also be electrically connected to the apparatus main body 11, such that the process cartridge 14 may be electrically connected to the apparatus main body 11 through the connection portion 132. By disposing the connection portion 132, it avoids that a gap may be between the contact portion 141 of the chip on the process cartridge 14 and the electrical contact portion 12 of the apparatus main body 11 due to installation error, such that electrical connection therebetween may not be realized, thereby ensuring data transmission stability between the process cartridge 14 and the apparatus main body 11.

For example, as shown in FIG. 4, a first groove 131b1 may be formed at the second side plate 131b to be engaged with the process cartridge 14 for position confining; and a second groove 131a1 may be formed at the first side plate 131a to be engaged with the process cartridge 14 for position confining. One end of a positioning axle of the process cartridge 14 may be disposed in the first groove 131b1, and another end of the positioning axle may be disposed in the second groove 131a1, which may realize position confining installation of the process cartridge 14 on the installation bracket 13 and limit position movement when the process cartridge 14 is pushed or pulled by the installation bracket 13.

As shown in FIG. 4, the connection portion 132 may include an avoiding groove 132b; and the avoiding groove 132b may be disposed opposite to the first groove 131b1. Since the connection portion 132 is disposed at the second side plate 131b, in order to install the positioning axle of the process cartridge 14 in the first groove 131b1, the avoiding groove 132b may be formed at the position of the connection portion 132 corresponding to the first groove 131b1, which may be convenient for the positioning axle of the process cartridge 14 to be installed in the first groove 131b1.

In some embodiments, taking any point of the first side plate 131a as a reference point, the conductive portion 132a may include a first docking portion 132a1 for being electrically connected to the electrical contact portion 12 of the image-forming apparatus 1. The distance between the first docking portion 132a1 and the reference point along the first direction X of the installation bracket 13 is L1; and the distance between the side of the second side plate 131b away from the first side plate 131a and the reference point along the first direction X of the installation bracket 13 is L2, where L1>L2.

In one embodiment, after the installation bracket 13 is installed in the apparatus main body 11, the first docking portion 132a1 may be in contact with the electrical contact portion 12 of the apparatus main body 11. By limiting the distance between the first docking portion 132a1 and the reference point along the first direction X to be greater than the distance between the side of the second side plate 131b away from the first side plate 131a and the reference point along the first direction X, the first docking portion 132a1 may be closer to the electrical contact portion 12 of the apparatus main body 11 than the first side plate 131a, which may prevent the second side plate 131b from colliding with the apparatus main body 11 when the installation bracket 13 is installed in the apparatus main body 11. Therefore, electrical connection stability between the first docking portion 132a1 and the electrical contact portion 12 of the apparatus main body 11 may be ensured, and positional interference may be avoided.

The conductive portion 132a may include a second docking portion 132a2 for being electrically connected to the contact portion 141 of the chip on the process cartridge 14; and the second docking portion 132a2 may be elastic.

In one embodiment, after the process cartridge 14 is installed on the installation bracket 13, the second docking portion 132a2 may be in contact with the contact portion 141 of the chip on the process cartridge 14; and after the installation bracket 13 carrying the process cartridge 14 is installed in the apparatus main body 11, the first docking portion 132a1 may be in contact with the electrical contact portion 12 of the apparatus main body 11, such that the conductive portion 132a may be respectively in contact with the contact portion 141 of the chip on the process cartridge 14 and the electrical contact portion 12 of the apparatus main body 11. Therefore, the conductive portion 132a may electrically connect the contact portion 141 of the chip on the process cartridge 14 and the electrical contact portion 12 of the apparatus main body 11.

Since the second docking portion 132a2 needs to be in contact with the contact portion 141 of the chip on the process cartridge 14, the second docking portion 132a2 may be configured as an elastic member such as an elastic piece, a spring or the like, such that the second docking portion 132a2 may move relative to the connection portion 132. That is, when the process cartridge 14 is installed on the installation bracket 13, the chip of the process cartridge 14 may move close to the second docking portion 132a2 and exert a force on the second docking portion 132a2. At this point, the second docking portion 132a2 may undergo elastic deformation; and the second docking portion 132a2 may be abutted against the contact portion 141 of the chip on the process cartridge 14 through own elastic force, which may improve electrical connection stability between the second docking portion 132a2 and the contact portion 141 of the chip on the process cartridge 14. Since the electrical contact portion 12 of the apparatus main body 11 can be configured as an elastic structure, the first docking portion 132a1 may be fixed on the connection portion 132. When the installation bracket 13 carrying the process cartridge 14 is installed in the apparatus main body 11, the first docking portion 132a1 may move close to the electrical contact portion 12 of the apparatus main body 11 and exert a force on the electrical contact portion 12 of the apparatus main body 11. At this point, the electrical contact portion 12 of the apparatus main body 11 may undergo elastic deformation; and the electrical contact portion 12 of the apparatus main body 11 may be abutted against the first docking portion 132a1 through own elastic force, which may ensure electrical connection stability between the electrical contact portion 12 and the first docking portion 132a1.

Furthermore, the distance between the connection portion 132 and the reference point along the first direction X of the installation bracket 13 is L3, where L3≤L1.

In one embodiment, by limiting the distance between another portion of the connection portion 132 except the first docking portion 132a1 and the reference point along the first direction X to be less than or equal to the distance between the first docking portion 132a1 and the reference point along the first direction X, the first docking portion 132a1 may be closer to the electrical contact portion 12 of the image-forming apparatus 1 than another portion of the connection portion 132 except the first docking portion 132a1, which may prevent another portion of the connection portion 132 except the first docking portion 132a1 from colliding with the electrical contact portion 12 of the apparatus main body 11 during the installation of the installation bracket 13 in the image-forming apparatus 1. Therefore, electrical connection stability between the first docking portion 132a1 and the electrical contact portion 12 of the apparatus main body 11 may be ensured.

As shown in FIGS. 3 and 4, in some embodiments, at least two connection portions 132 including a first connection portion and a second connection portion may be configured. The first connection portion and the second connection portion may be arranged sequentially along a second direction Y. The second direction Y may be the direction that the installation bracket 13 is installed in the image-forming apparatus 1. The second direction Y may intersect the first direction X. For example, the second direction Y may be perpendicular or substantially perpendicular to the first direction X. The distance along the first direction between the first docking portion on the first connection portion and the reference point is a, and the distance along the first direction between the first docking portion on the second connection portion and the reference point is b, where a is greater than b.

As shown in FIG. 3, four process cartridges 14 may be installed on the installation bracket 13; and four connection portions 132 may be configured accordingly. Four connection portions 132 may be arranged sequentially along the second direction Y, and each connection portion 132 may be configured with the conductive portion 132a. Optionally, the quantity of connection portions 132 may also be configured as a different number. If the quantity of the contact portions of the chip on the process cartridge 14 is n, and n≥1, the quantity of the electrical contact portions 12 configured corresponding to one process cartridge 14 on the image-forming apparatus 1 may also be n. Therefore, it ensures that n conductive portions 132a insulated from each other may be configured corresponding to each process cartridge 14; and each contact portion 141 of the chip on the process cartridge 14 may have the conductive portion 132a which may be electrically connected to the electrical contact portion corresponding to the image-forming apparatus 1. Different conductive parts 132a may be insulated from each other. For example, the connection portions 132 corresponding to different process cartridges 14 may be connected through insulators. Optionally, n=4. Obviously, based on different configurations of the image-forming apparatus 1 and the process cartridge 14, n may also be other numbers, such as n−1, n−2, n−3, n−5, n−6 and the like.

As shown in FIGS. 3 and 4, relative to the second side plate 131b, the protruding distance of four connection portions 132 on the installation bracket 13 away from the first side plate 131a may decrease sequentially along the second direction Y. The apparatus main body 11 may be also disposed with four electrical contact portions 12 corresponding to the connection portions 132. Taking the rightmost connection portion 132 in FIG. 4 as an example, when the installation bracket 13 is installed in the apparatus main body 11, the connection portion 132 that first enters the apparatus main body 11 may be the rightmost connection portion 132 in FIG. 4. When the rightmost connection portion 132 in FIG. 4 passes the first three electrical contact portions 12 in the apparatus main body 11, the distances between the first three electrical contact portions 12 and the rightmost connection portion 132 in FIG. 4 may be relatively large, which may prevent positional interference problems and also prevent the installation bracket 13 or the apparatus main body 11 from being scratched.

As shown in FIGS. 3 and 4, in some embodiments, the connection portion 132 may be higher than the second side plate 131b along a third direction Z; and the third direction Z may be the height direction of the second side plate 131b. The third direction Z may intersect the first direction X. For example, the first direction X and the third direction Z may be perpendicular to each other.

The connection portion 132 may be a plate-like structure. The second direction Y and the third direction Z may be in parallel or approximately parallel with the plane where the connection portion 132 is located. The first direction X may be perpendicular or approximately perpendicular to the plane where the connection portion 132 is located.

In one embodiment, along the third direction Z, the connection portion 132 may be disposed above the second side plate 131b. When the process cartridge 14 is installed on the installation bracket 13, the connection portion 132 may be electrically connected to the process cartridge 14; and the connection portion 132 may also be used as a reference and position confining for the installation of the process cartridge 14, such that the process cartridge 14 may be aligned with the installation position on the installation bracket 13. In such way, it may prevent the problems that the end of the process cartridge 14 adjacent to the second side plate 131b may protrude excessively from the installation bracket 13, when the process cartridge 14 is installed, to result in that the installation bracket 13 cannot be pushed in the apparatus main body 11; and the cooperation between the end of the process cartridge 14 adjacent to the first side plate 131a and a driving assembly may be affected.

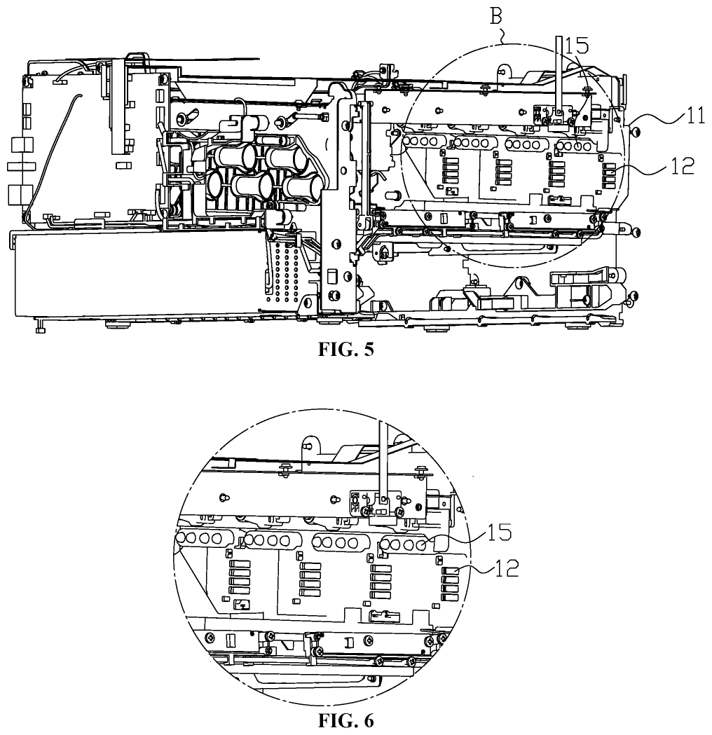

As shown in FIGS. 3, 5 and 6, in some embodiments, along the third direction Z, the highest point of the connection portion 132 may be lower than a first electrical connection portion 142 of the process cartridge 14 when the process cartridge 14 is installed on the installation bracket 13. In such way, the first electrical connection portion 142 on the process cartridge 14 may be electrically connected to the second electrical connection portion of the apparatus main body 11, thereby ensuring normal operation of the image-forming apparatus 1.

Optionally, it may also configure that, along the third direction Z, the highest point of the connection portion 132 may be higher than the first electrical connection portion 142 of the process cartridge 14 when the process cartridge 14 is installed on the installation bracket 13; and the connection portion 132 may also include an avoiding portion. The avoiding portion may be a through hole passing through the connection portion 132 along the first direction X, or may be formed by recessing a part of the connection portion 132 along the third direction Z. The avoiding portion may be configured to give way to (i.e., avoid) the electrical connection between the first electrical connection portion 142 of the process cartridge 14 and a second electrical connection portion 15 of the image-forming apparatus 1, which may realize electrical connection between the first electrical connection portion 142 on the process cartridge 14 and the second electrical connection of the apparatus main body 11, thereby ensuring normal operation of the image-forming apparatus 1.

Optionally, it may also configure that the connection portion 132 may be disposed with a third electrical connection portion. The third electrical connection portion may be configured to be electrically connected to the first electrical connection portion 142 of the process cartridge 14 and the second electrical connection portion 15 of the image-forming apparatus 1 respectively, which may realize connection between the first electrical connection portion 142 on the process cartridge 14 and the apparatus main body, thereby ensuring normal operation of the image-forming apparatus 1.

In some embodiments, the connection portion 132 and the bracket main body 131 may be formed into an integral structure. The connection portion 132 and the bracket main body 131 may be formed using a mold to save time. Optionally, the connection portion 132 and the bracket main body 131 may also be separate structures. After the connection portion 132 and the bracket main body 131 are respectively manufactured and formed, the connection portion 132 and the bracket main body 131 may be fixedly connected through a connection part or a welding manner to simplify the process.

The above are only optional embodiments of the present disclosure and are not intended to limit the present application. For those skilled in the art, the present application may have various modifications and changes. Any modifications, equivalent replacements, improvements and the like made within the spirit and principle of the present disclosure shall be included in the protection scope of the present disclosure.

What is claimed is:

1. An installation bracket, configured to carry a process cartridge, comprising:
a bracket main body; and
a connection portion, disposed on the bracket main body, wherein:
the connection portion includes a conductive portion, configured to electrically connect a contact portion of a chip on the process cartridge and an electrical contact portion of an image-forming apparatus.

2. The installation bracket according to claim 1, wherein:
the bracket main body includes a first side plate and a second side plate arranged sequentially along a first direction, and the connection portion is located on the second side plate;
when the installation bracket is installed in the image-forming apparatus, the second side plate is adjacent to the electrical contact portion of the image-forming apparatus relative to the first side plate; and
when the installation bracket is configured to carry the process cartridge, the connection portion is capable of being electrically connected to the process cartridge.

3. The installation bracket according to claim 2, wherein:
any point of the first side plate is configured as a reference point; and
the conductive portion includes a first docking portion configured to be electrically connected to the electrical contact portion of the image-forming apparatus; a distance between the first docking portion and the reference point along the first direction of the installation bracket is L1; and a distance between a side of the second side plate away from the first side plate and the reference point along the first direction of the installation bracket is L2, wherein L1>L2.

4. The installation bracket according to claim 3, wherein:
a quantity of connection portions is at least two; the connection portions include a first connection portion and a second connection portion arranged sequentially along a second direction; the second direction is a direction of installing the installation bracket into the image-forming apparatus; the second direction intersects with the first direction; and a distance between a first docking portion on the first connection portion and the reference point along the first direction is a, and a distance between a first docking portion on the second connection portion and the reference point along the first direction is b, wherein a is greater than b.

5. The installation bracket according to claim 3, wherein:
a distance between the connection portion and the reference point along the first direction of the installation bracket is L3, wherein L3≤L1.

6. The installation bracket according to claim 2, wherein:
the connection portion is higher than the second side plate along a third direction; and the third direction is a height direction of the second side plate and intersects with the first direction.

7. The installation bracket according to claim 6, wherein:
along the third direction, a highest point of the connection portion is lower than a first electrical connection portion of the process cartridge when the process cartridge is installed on the installation bracket; and/or
along the third direction, a highest point of the connection portion is higher than a first electrical connection portion of the process cartridge when the process cartridge is installed on the installation bracket; and the connection portion further includes an avoiding portion configured to give way to an electrical connection between the first electrical connection portion of the process cartridge and the second electrical connection portion of the image-forming apparatus; and/or
the connection portion is disposed with a third electrical connection portion configured to be electrically connected to the first electrical connection portion of the process cartridge and the second electrical connection portion of the image-forming apparatus, respectively.

8. The installation bracket according to claim 2, wherein:
the second side plate is provided with a first groove engaged with the process cartridge for position confining.

9. The installation bracket according to claim 8, wherein:
the connection portion includes an avoiding groove disposed oppositely to the first groove.

10. The installation bracket according to claim 3, wherein:
the conductive portion includes a second docking portion configured to be electrically connected to the contact portion of the chip on the process cartridge; and the second docking portion is elastic.

11. The installation bracket according to claim 1, wherein:
the connection portion and the bracket main body are an integrated structure or separate structures.

12. A process cartridge assembly, comprising:
an installation bracket and a process cartridge, wherein:
the installation bracket is configured to carry the process cartridge and includes a bracket main body and a connection portion disposed on the bracket main body; and the connection portion includes a conductive portion, configured to electrically connect a contact portion of a chip on the process cartridge and an electrical contact portion of an image-forming apparatus; and
the process cartridge is installed on the installation bracket; and the process cartridge includes a contact portion electrically connected to a first docking portion.

13. An image-forming apparatus, comprising:
an electrical contact portion; and
an installation bracket disposed removably, wherein when the installation bracket is installed in the image-forming apparatus, a conductive portion is electrically connected to the electrical contact portion.

14. The image-forming apparatus according to claim 13, further including:
a process cartridge, wherein the process cartridge is installed on the installation bracket and includes a contact portion; and when the process cartridge is installed on the installation bracket and the installation bracket is installed in the image-forming apparatus, the conductive portion is electrically connected to the electrical contact portion and the contact portion respectively.
